(19) United States
(12) Patent Application Publication
(10) Pub. No.: US 2024/0004141 A1
(43) Pub. Date: Jan. 4, 2024

(54) OPTICAL DEVICE AND OPTICAL COMMUNICATION APPARATUS

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/324,755

(22) Filed: May 26, 2023

(30) Foreign Application Priority Data
Jul. 1, 2022 (JP) 2022-107132

(51) Int. Cl. G02B 6/30

(52) U.S. Cl. CPC G02B 6/305

(57) ABSTRACT

An optical device includes two first waveguides arranged side by side, and a single second waveguide arranged so as to be side by side with and away from the first waveguides. The first waveguide includes first tapered waveguide and second tapered waveguide. The second waveguide includes a third tapered waveguide and a third waveguide. The first tapered waveguide is constituted such that width is wider as the first tapered waveguide is closer to the second tapered waveguide. The second tapered waveguide is constituted such that width is narrower as the second tapered waveguide is farther away from the first tapered waveguide. The third tapered waveguide is constituted such that width is wider as the third tapered waveguide is closer to the third waveguide. The first waveguide has a structure constituted such that first gap between the two first waveguides is made wider than second gap between the two first waveguides.

### CROSS-REFERENCE TO RELATED APPLICATION

This application is based upon and claims the benefit of priority of the prior Japanese Patent Application No. 2022-107132, filed on Jul. 1, 2022, the entire contents of which are incorporated herein by reference.

### FIELD

The embodiments discussed herein are related to an optical device and an optical communication apparatus.

### BACKGROUND

In recent years, there are increased demands for optical fiber communication in accordance with an increase in communication capacity, so that small-sized optical devices that convert electrical signals to optical signals are used. Accordingly, in recent years, development of an ultra-compact substrate type optical waveguide element (hereinafter, simply referred to as an optical device) represented by silicon photonics is actively studied. In the optical device, two or more waveguides made of different materials can be integrally mounted on a same chip.

The optical components constituting the optical device each have a different characteristic depending on, for example, a material refractive index, so that it is possible to improve the characteristic of the optical device by using a waveguide made of a suitable material for each of the optical components. Therefore, the optical device constituted by using waveguides that are made of different materials has a structure in which light exhibits indirect transition between different waveguides.

FIG. 14 is a diagram illustrating one example of an optical device 200 that is conventionally used. The optical device 200 illustrated in FIG. 14 is a substrate type optical waveguide element that is optically coupled to a core FC included in an optical fiber. The optical device 200 includes, for example, Si₃N₄ waveguide (hereinafter, simply referred to as a Silicon Nitride (SiN) waveguide) 201 that is covered by a SiO₂ clad 211, and includes, for example, a Si waveguide (hereinafter, simply referred to as a Si waveguide) 202 that is covered by the clad 211. The optical device 200 includes an adiabatic conversion unit 203 in which light exhibits indirect transition between the Si waveguide 202 and the SiN waveguide 201.

The SiN waveguide 201 is a straight line waveguide in which the waveguide width from a start point X201 to an end point X202 is constant. The start point X201 of the SiN waveguide 201 starts from a chip end surface D1 of the optical device 200 that is optically coupled to the core FC included in the optical fiber.

The Si waveguide 202 includes a tapered waveguide 202A and a straight line waveguide 202B. The tapered waveguide 202A is a waveguide having a tapered structure in which the waveguide width is gradually wider from a start point Y201 to an end point Y202. The straight line waveguide 202B is a waveguide in which the waveguide width from a start point Y202 to an end point Y203 is constant. The Si waveguide 202 is constituted by allowing the end point Y202 of the tapered waveguide 202A to be optically coupled to the start point Y202 of the straight line waveguide 202B. The end point Y203 of the straight line waveguide 202B included in the Si waveguide 202 ends at a chip end surface D2 that is located opposite the chip end surface D1 of the optical device 200.

The adiabatic conversion unit 203 is in a state in which, at the start point, a mid point X203 of the SiN waveguide 201 is away from the start point Y201 of the tapered waveguide 202A included in the Si waveguide 202. The adiabatic conversion unit 203 is in a state in which, at the end point, the end point X202 of the SiN waveguide 201 is away from the end point Y202 of the tapered waveguide 202A included in the Si waveguide 202. The adiabatic conversion unit 203 has a structure in which the SiN waveguide 201 is disposed on the Si waveguide 202 via the clad 211.

FIG. 15A is a diagram illustrating one example of a schematic cross-sectional portion taken along line A-A illustrated in FIG. 14. The schematic cross-sectional portion illustrated in FIG. 15A is a cross-sectional part of the optical device 200 in which the SiN waveguide 201 is arranged. The optical device 200 includes a Si substrate 212, the clad 211 that is laminated on the Si substrate 212, and the SiN waveguide 201 that is arranged in the interior of the clad 211.

FIG. 15B is a diagram illustrating one example of a schematic cross-sectional portion taken along line B-B illustrated in FIG. 14. The schematic cross-sectional portion illustrated in FIG. 15B is a cross-sectional part of the optical device 200 in which the adiabatic conversion unit 203 is arranged. The optical device 200 includes the Si substrate 212, the clad 211 that is laminated on the Si substrate 212, the SiN waveguide 201 that is arranged in the interior of the clad 211, and the tapered waveguide 202A that is arranged below the SiN waveguide 201 in the interior of the clad 211.

FIG. 15C is a diagram illustrating one example of a schematic cross-sectional portion taken along line C-C illustrated in FIG. 14. The schematic cross-sectional portion illustrated in FIG. 15C is a cross-sectional part of the optical device 200 in which the straight line waveguide 202B included in the Si waveguide 202 is arranged. The optical device 200 includes the Si substrate 212, the clad 211, and the straight line waveguide 202B that is arranged in the interior of the clad 211.

Then, in the adiabatic conversion unit 203, light is adiabatically and gradually transitioned between the tapered waveguide 202A included in the Si waveguide 202 and the SiN waveguide 201.

In the adiabatic conversion unit 203 included in the conventional optical device 200, the waveguide width of the Si waveguide 202 is changed in a tapered manner, and the refractive index of the SiN waveguide 201 is lower than that of the Si waveguide 202, so that a mode field of light is set to be large in order to approach the mode field of the optical fiber. As a result, it is possible to decrease a coupling loss with the optical fiber.
Patent Document 1: Japanese Laid-open Patent Publication No. 2014-191301
Patent Document 2: U.S. Patent Application Publication No. 2019/0154919
Patent Document 3: U.S. patent Ser. No. 10/429,582
Patent Document 4: Japanese Laid-open Patent Publication No. 2011-22464

However, in the conventional optical device 200, the mode field of the SiN waveguide 201 is smaller than the mode field of the optical fiber. Accordingly, in the optical device 200, a coupling loss with the optical fiber occurs caused by a mismatch of the mode field between the SiN waveguide 201 and the optical fiber.

### SUMMARY

According to an aspect of an embodiment, an optical device includes two first waveguides that are arranged side by side on a substrate, and a single second waveguide that is arranged, on the substrate, so as to be side by side with and away from the first waveguides. Each of the first waveguides includes a first tapered waveguide, and a second tapered waveguide that is connected to the first tapered waveguide. The second waveguide includes a third tapered waveguide that is disposed side by side with the first waveguides, and a third waveguide that is connected to the third tapered waveguide on a side opposite to a side on which the first tapered waveguides are provided. Each of the first tapered waveguides has a structure constituted such that a waveguide width is gradually wider as the first tapered waveguide is closer to the associated second tapered waveguide. Each of the second tapered waveguides has a structure constituted such that a waveguide width is gradually narrower as the second tapered waveguide is farther away from the associated first tapered waveguide. The third tapered waveguide has a structure constituted such that a waveguide width is gradually wider as the third tapered waveguide is closer to the third waveguide. Each of the first waveguides has a structure constituted such that a first gap between the two first waveguides at a start point of each of the first tapered waveguides is made wider than a second gap between the two first waveguides at a connection portion between each of the first tapered waveguides and the associated second tapered waveguides.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of an optical device according to a first embodiment;

FIG. 2A is a diagram illustrating one example of a schematic cross-sectional portion taken along line A-A illustrated in FIG. 1;

FIG. 2B is a diagram illustrating one example of a schematic cross-sectional portion taken along line B-B illustrated in FIG. 1;

FIG. 2C is a diagram illustrating one example of a schematic cross-sectional portion taken along line C-C illustrated in FIG. 1;

FIG. 3 is a diagram illustrating one example of an optical device according to a second embodiment;

FIG. 4A is a diagram illustrating one example of a schematic cross-sectional portion taken along line A-A illustrated in FIG. 3;

FIG. 4B is a diagram illustrating one example of a schematic cross-sectional portion taken along line B-B illustrated in FIG. 3;

FIG. 4C is a diagram illustrating one example of a schematic cross-sectional portion taken along line C-C illustrated in FIG. 3;

FIG. 5 is a diagram illustrating one example of an optical device according to a third embodiment;

FIG. 6A is a diagram illustrating one example of a schematic cross-sectional portion taken along line A-A illustrated in FIG. 5;

FIG. 6B is a diagram illustrating one example of a schematic cross-sectional portion taken along line B-B illustrated in FIG. 5;

FIG. 6C is a diagram illustrating one example of a schematic cross-sectional portion taken along line C-C illustrated in FIG. 5;

FIG. 7 is a diagram illustrating one example of an optical communication apparatus in which the optical device is built in;

FIG. 8 is a diagram illustrating one example of an optical device according to a comparative example 1;

FIG. 9A is a diagram illustrating one example of a schematic cross-sectional portion taken along line A-A illustrated in FIG. 8;

FIG. 9B is a diagram illustrating one example of a schematic cross-sectional portion taken along line B-B illustrated in FIG. 8;

FIG. 9C is a diagram illustrating one example of a schematic cross-sectional portion taken along line C-C illustrated in FIG. 8;

FIG. 10 is a diagram illustrating one example of an optical device according to a comparative example 2;

FIG. 11A is a diagram illustrating one example of a schematic cross-sectional portion taken along line A-A illustrated in FIG. 10;

FIG. 11B is a diagram illustrating one example of a schematic cross-sectional portion taken along line B-B illustrated in FIG. 10;

FIG. 11C is a diagram illustrating one example of a schematic cross-sectional portion taken along line C-C illustrated in FIG. 10;

FIG. 12 is a diagram illustrating one example of an optical device according to a comparative example 3;

FIG. 13A is a diagram illustrating one example of a schematic cross-sectional portion taken along line A-A illustrated in FIG. 12;

FIG. 13B is a diagram illustrating one example of a schematic cross-sectional portion taken along line B-B illustrated in FIG. 12;

FIG. 13C is a diagram illustrating one example of a schematic cross-sectional portion taken along line C-C illustrated in FIG. 12;

FIG. 14 is a diagram illustrating one example of a conventional optical device;

FIG. 15A is a diagram illustrating one example of a schematic cross-sectional portion taken along line A-A illustrated in FIG. 14;

FIG. 15B is a diagram illustrating one example of a schematic cross-sectional portion taken along line B-B illustrated in FIG. 14; and

FIG. 15C is a diagram illustrating one example of a schematic cross-sectional portion taken along line C-C illustrated in FIG. 14.

### DESCRIPTION OF EMBODIMENTS

### Comparative Example 1

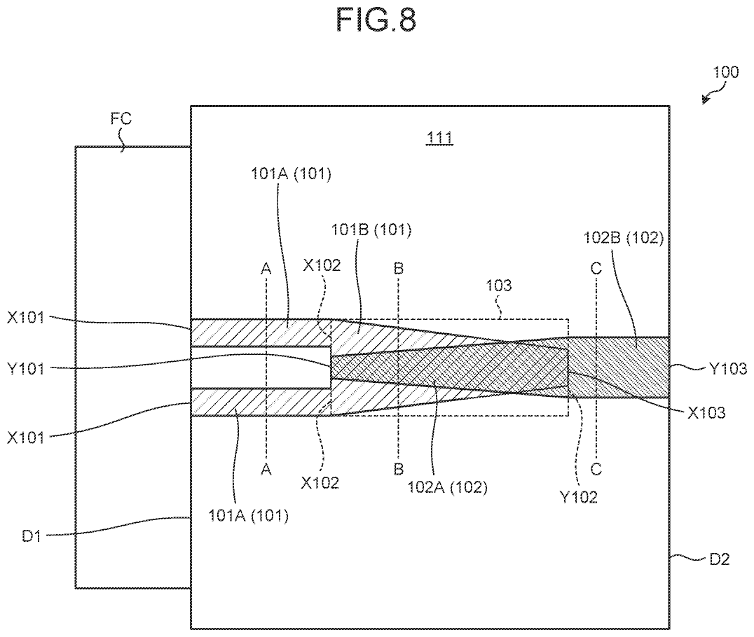

FIG. 8 is a diagram illustrating one example of an optical device 100 according to a comparative example 1. The optical device 100 illustrated in FIG. 8 is a substrate type optical waveguide element that is optically coupled to a core FC included in an optical fiber. The optical device 100 includes a SiN waveguide 101, a Si waveguide 102, and a clad 111 that covers the Si waveguide 102 and the SiN waveguide 101. Furthermore, the optical device 100 includes an adiabatic conversion unit 103 in which a portion between the Si waveguide 102 and the SiN waveguide 101 is optically coupled on the basis of an indirect transition. The SiN waveguide 101 is made of, for example, Si₃N₄ (hereinafter, simply referred to as SiN), and the material refractive index of SiN at the time of an optical wavelength of 1.55 μm is 1.99. The Si waveguide 102 is made of, for example, Si, and the material refractive index of Si at the time of an optical wavelength of 1.55 μm is 3.48. The clad 111 is made of, for example, SiO₂, and the material refractive index of SiO₂ at the time of an optical wavelength of 1.55 μm is 1.44.

The SiN waveguide 101 includes two first straight line waveguides 101A, and a first tapered waveguide 101B that is optically coupled to the two first straight line waveguides 101A. Each of the first straight line waveguides 101A is a waveguide in which the waveguide width from a start point X101 to an end point X102 is constant. The first tapered waveguide 101B is a waveguide having a tapered structure in which the waveguide width is gradually narrower from the end point X102 of each of the first straight line waveguides 101A toward the end point X103. The waveguide width of the first tapered waveguide 101B at the start point X102 is wider than the waveguide width of the first tapered waveguide 101B at the end point X103. The thickness of the core of each of the first straight line waveguides 101A is set to be the same as that of the first tapered waveguide 101B. The start point X101 of the SiN waveguide 101 starts from the chip end surface D1 of the optical device 100 that is optically coupled to the core FC included in the optical fiber.

The Si waveguide 102 includes a second tapered waveguide 102A and a second straight line waveguide 102B that is optically coupled to the second tapered waveguide 102A. The second tapered waveguide 102A is a waveguide having a tapered structure in which the waveguide width is gradually wider from the start point Y101 toward the end point Y102. The second straight line waveguide 102B is a waveguide in which the waveguide width from the start point Y102 toward the end point Y103 is constant. The thickness of the core of the second straight line waveguide 102B is set to be the same as that of the second tapered waveguide 102A. The end point Y103 of the second straight line waveguide 102B included in the Si waveguide 102 ends at the chip end surface D2 that is disposed opposite the chip end surface D1 of the optical device 100.

The adiabatic conversion unit 103 is constituted such that the second tapered waveguide 102A is arranged below the first tapered waveguide 101B in an overlapped manner with a space, in the vertical direction, between the first tapered waveguide 101B and the second tapered waveguide 102A. Furthermore, a gap between the first tapered waveguide 101B and the second tapered waveguide 102A is set to be constant.

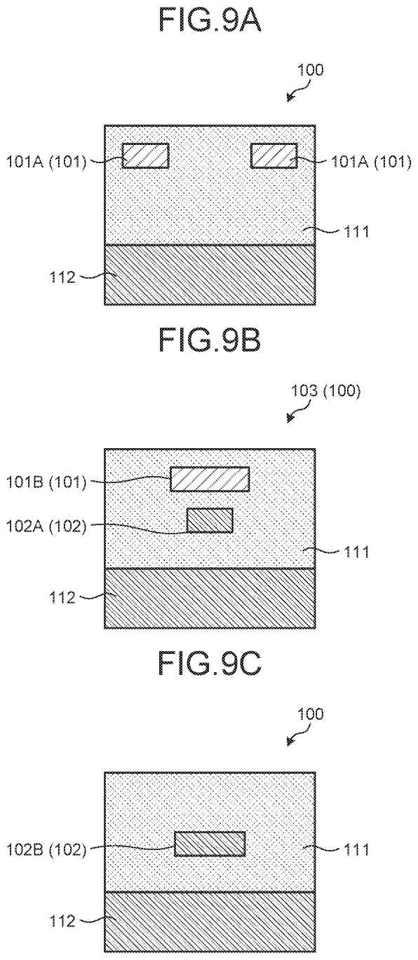

The adiabatic conversion unit 103 includes a start point X102 (Y101), an end point X103 (Y102), and an intermediate portion that is located between the start point and the end point. FIG. 9A is a diagram illustrating one example of a schematic cross-sectional portion taken along line A-A illustrated in FIG. 8. The schematic cross-sectional portion taken along the line A-A illustrated in FIG. 9A is a cross-sectional part of the optical device 100 in which the two first straight line waveguides 101A included in the SiN waveguide 101 are arranged. The optical device 100 includes a Si substrate 112, the clad 111 that is laminated on the Si substrate 112, and the two first straight line waveguides 101A that are arranged in the interior of the clad 111.

FIG. 9B is a diagram illustrating one example of a schematic cross-sectional portion taken along line B-B illustrated in FIG. 8. The schematic cross-sectional portion taken along the line B-B illustrated in FIG. 9B is a cross-sectional part of the optical device 100 in which the adiabatic conversion unit 103 is arranged. The optical device 100 includes the Si substrate 112, the clad 111 that is laminated on the Si substrate 112, the first tapered waveguide 101B that is arranged in the interior of the clad 111, and the second tapered waveguide 102A that is arranged in the interior of the clad 111. It is assumed that the structure is constituted such that, at the start point of the adiabatic conversion unit 103, the waveguide width of the first tapered waveguide 101B is wider than the waveguide width of the second tapered waveguide 102A. The gap between the first tapered waveguide 101B and the second tapered waveguide 102A is set to be constant. It is assumed that the structure is constituted such that, at the end point of the adiabatic conversion unit 103, the waveguide width of the first tapered waveguide 101B is narrower than the waveguide width of the second tapered waveguide 102A.

FIG. 9C is diagram illustrating one example of a schematic cross-sectional portion taken along C-C illustrated in FIG. 8. The schematic cross-sectional portion taken along the line C-C illustrated in FIG. 9C is a cross-sectional part of the optical device 100 in which the second straight line waveguide 102B included in the Si waveguide 102 is arranged. The optical device 100 includes the Si substrate 112, the clad 111 that is laminated on the Si substrate 112, and the second straight line waveguide 102B that is included in the Si waveguide 102 and that is arranged in the interior of the clad 111.

It is assumed that the structure is constituted such that, at the start point of the adiabatic conversion unit 103, the waveguide width of the first tapered waveguide 101B is wider, and the waveguide width of the second tapered waveguide 102A is narrower, whereas, at the end point, the waveguide width of the first tapered waveguide 101B is narrower, and the waveguide width of the second tapered waveguide 102A is wider. In other words, the structure is constituted such that the waveguide width of the first tapered waveguide 101B is gradually narrower from the start point X102 toward the end point X103, whereas the waveguide width of the second tapered waveguide 102A is gradually wider from the start point Y101 toward the end point Y102. In general, confinement of light to the core is stronger as the waveguide width of a waveguide is wider, so that the effective refractive index is increased affected by the material refractive index of the core.

In the optical device 100 according to the comparative example 1, the structure is constituted such that the SiN waveguide 101 that is optically coupled to the core FC included in the optical fiber is divided into the two first straight line waveguides 101A. As a result, as compared to the conventional optical device 200, it is possible to suppress a coupling loss with the optical fiber by making the mode field of the SiN waveguide 101 closer to the mode field of the optical fiber.

In addition, in the adiabatic conversion unit 103 included in the optical device 100, the two first straight line waveguides 101A are optically coupled to a single piece of the first tapered waveguide 101B, and light is accordingly adiabatically transitioned from the first tapered waveguide 101B to the second tapered waveguide 102A that is the Si waveguide.

However, the mode field of the light is sharply changed at a discontinuous portion that is included in the SiN waveguide 101 and in which the single piece of the first tapered waveguide 101B is optically coupled to the two first straight line waveguides 101A, so that a radiation loss or a reflection loss of light occurs. Accordingly, in order to cope with the circumstances, it is conceivable to use an optical device 100A according to the comparative example 2.

### Comparative Example 2

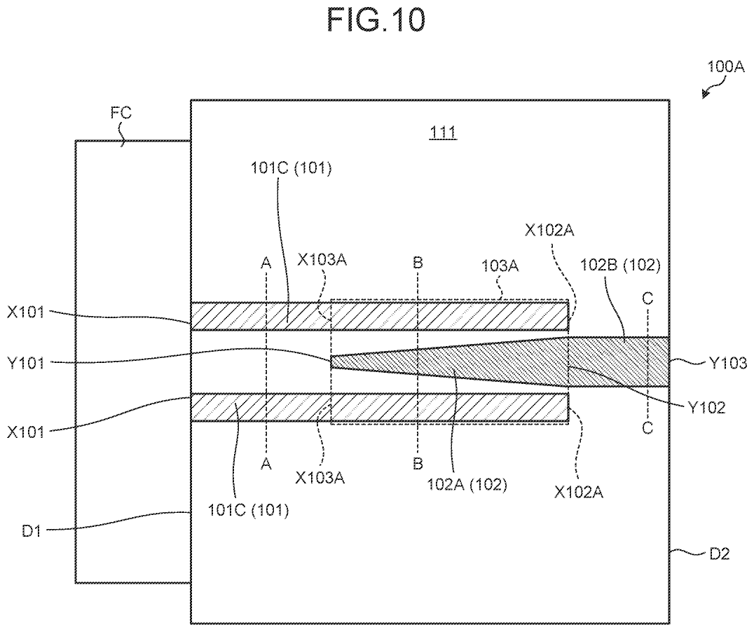

FIG. 10 is a diagram illustrating one example of the optical device 100A according to the comparative example 2. The optical device 100A illustrated in FIG. 10 is a substrate type optical waveguide element that is optically coupled to the core FC included in the optical fiber. The optical device 100A includes the SiN waveguide 101, the Si waveguide 102, and the clad 111 that covers the Si waveguide 102 and the SiN waveguide 101. Furthermore, the optical device 100A includes an adiabatic conversion unit 103A in which a portion between the Si waveguide 102 and the SiN waveguide 101 is optically coupled on the basis of an indirect transition.

The SiN waveguide 101 includes two straight line waveguides 101C in which the waveguide width between the start point X101 and the end point X102A is constant. The start point X101 of the SiN waveguide 101 starts from the chip end surface D1 of the optical device 100 that is optically coupled to the core FC included in the optical fiber.

The Si waveguide 102 includes the second tapered waveguide 102A and the second straight line waveguide 102B that is optically coupled to the second tapered waveguide 102A. The second tapered waveguide 102A is a waveguide that has a tapered structure in which the waveguide width is gradually wider from the start point Y101 toward the end point Y102. The second straight line waveguide 102B is a waveguide in which the waveguide width from the start point Y102 toward the end point Y103 is constant. The thickness of the core of the second straight line waveguide 102B is set to be the same as that of the second tapered waveguide 102A. The end point Y103 of the second straight line waveguide 102B included in the Si waveguide 102 ends at the chip end surface D2 that is disposed opposite the end point of the chip end surface D1 included in the optical device 100.

The adiabatic conversion unit 103A is constituted such that the second tapered waveguide 102A is arranged between the two straight line waveguides 101C, and the second tapered waveguide 102A is arranged below the straight line waveguides 101C in a state in which a portion between a part of the straight line waveguides 101C and the second tapered waveguide 102A is separated. In addition, a gap between each of the straight line waveguides 101C and the second tapered waveguide 102A is set to be constant. In the adiabatic conversion unit 103A, the second tapered waveguide 102A is arranged between the two straight line waveguides 101C such that the two straight line waveguides 101C are not optically coupled. In addition, the mode field is present across a portion that is located mainly around the two straight line waveguides 101C even if the SiN waveguide 101 is not located directly above the Si waveguide 102, so that light is adiabatically transitioned from the SiN waveguide 101 to the Si waveguide 102.

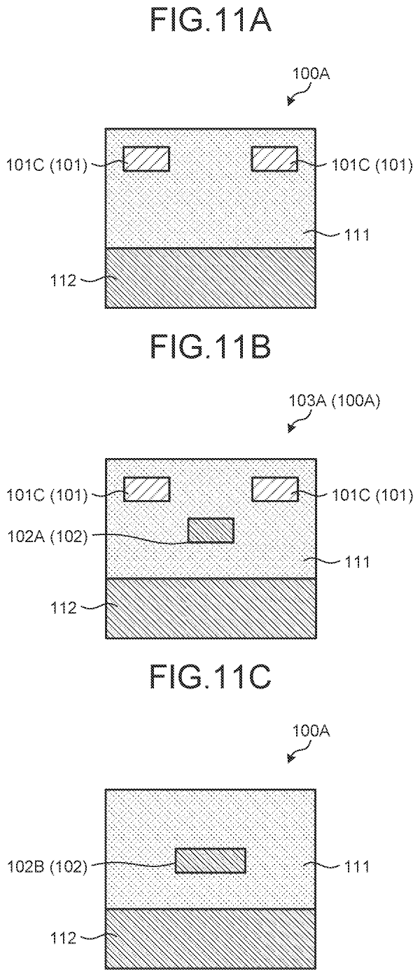

The adiabatic conversion unit 103A includes the start point X102A (Y101), the end point X103A (Y102), and an intermediate portion that is located between the start point and the end point. FIG. 11A is a diagram illustrating one example of a schematic cross-sectional portion taken along line A-A illustrated in FIG. 10. The schematic cross-sectional portion taken along line A-A illustrated in FIG. 11A is a cross-sectional part of the optical device 100A in which the two straight line waveguides 101C included in the SiN waveguide 101 are arranged. The optical device 100A includes the Si substrate 112, the clad 111 that is laminated on the Si substrate 112, and the two straight line waveguides 101C that are arranged in the SiN waveguide 101 in the interior of the clad 111.

FIG. 11B is a diagram illustrating one example of the schematic cross-sectional portion taken along line B-B illustrated in FIG. 10. The schematic cross-sectional portion taken along the line B-B illustrated in FIG. 11B is a cross-sectional part of the optical device 100A in which the adiabatic conversion unit 103A is arranged. The optical device 100A includes the Si substrate 112, the clad 111 that is laminated on the Si substrate 112, the two straight line waveguides 101C that are disposed in the interior of the clad 111, and the second tapered waveguide 102A that is disposed in the interior of the clad 111. The adiabatic conversion unit 103A has a structure in which the second tapered waveguide 102A is disposed, between the two straight line waveguides 101C, side by side with the two straight line waveguides 101C at the position below the two straight line waveguides 101C. The gap between each of the straight line waveguides 101C and the second tapered waveguide 102A is set to be constant.

FIG. 11C is a diagram illustrating one example of a schematic cross-sectional portion taken along line C-C illustrated in FIG. 10. The schematic cross-sectional portion taken along the line C-C illustrated in FIG. 11C is a cross-sectional part of the optical device 100A in which the second straight line waveguide 102B included in the Si waveguide 102 is arranged. The optical device 100A includes the Si substrate 112, the clad 111 that is laminated on the Si substrate 112, and the second straight line waveguide 102B that is arranged in the interior of the clad 111.

In the adiabatic conversion unit 103A according to the comparative example 2, the second tapered waveguide 102A is arranged between the two straight line waveguides 101C such that the two straight line waveguides 101C are not optically coupled, so that light is adiabatically transitioned from the straight line waveguide 101C to the second tapered waveguide 102A. As a result, a discontinuous portion is not present in the SiN waveguide 101, so that it is possible to suppress an occurrence of a radiation loss or a reflection loss of light.

However, in the adiabatic conversion unit 103A, confinement of light in the two straight line waveguides 101C is weak, and thus, a radiation loss at the start point Y101 of the second tapered waveguide 102A included in the Si waveguide 102 is increased. As a result, the size of parts is increased because the length of the adiabatic conversion unit 103A in which the Si waveguide 102 and the SiN waveguide 101 are arranged side by side with a space each other is needed to some extent. Accordingly, in order to cope with the circumstances, it is conceivable to use an optical device 100B according to a comparative example 3.

### Comparative Example 3

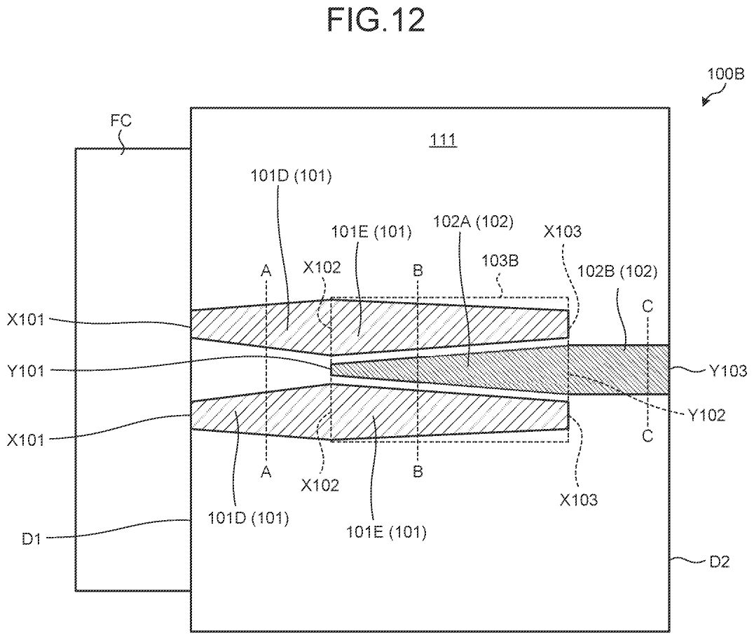

FIG. 12 is a diagram illustrating one example of the optical device 100B according to the comparative example 3. The optical device 100B illustrated in FIG. 12 is a substrate type optical waveguide element that is optically coupled to the core FC included in the optical fiber. The optical device 100B includes the SiN waveguide 101, the Si waveguide 102, and the clad 111 that covers the Si waveguide 102 and the SiN waveguide 101. Furthermore, the optical device 100B includes an adiabatic conversion unit 103B in which a portion between the Si waveguide 102 and the SiN waveguide 101 is optically coupled on the basis of an indirect transition.

The SiN waveguide 101 includes two third tapered waveguides 101D and two fourth tapered waveguides 101E. Each of the two third tapered waveguides 101D is a waveguide having a structure in which the waveguide width is gradually wider from the start point X101 toward the end point X102. Each of the two fourth tapered waveguides 101E is a waveguide having a structure in which the waveguide width is gradually narrower from the start point X102 toward the end point X103. The end point X102 of each of the two third tapered waveguides 101D is optically coupled to the start point X102 of the two fourth tapered waveguides 101E, so that a portion between each of the two third tapered waveguides 101D and the associated two fourth tapered waveguides 101E is optically coupled. The thickness of the core of the two third tapered waveguides 101D is set to be the same as that of the two fourth tapered waveguides 101E. The start point X101 of the SiN waveguide 101 starts at the chip end surface D1 of the optical device 100 that is optically coupled to the core FC included in the optical fiber.

The Si waveguide 102 includes the second tapered waveguide 102A and the second straight line waveguide 102B that is optically coupled to the second tapered waveguide 102A. The second tapered waveguide 102A is a waveguide having a tapered structure in which the waveguide width is gradually wider from the start point Y101 toward the end point Y102. The second straight line waveguide 102B is a waveguide in which the waveguide width from the start point Y102 toward the end point Y103 is constant. The thickness of the core of the second straight line waveguide 102B is set to be the same as that of the second tapered waveguide 102A. The end point Y103 of the second straight line waveguide 102B included in the Si waveguide 102 ends at the chip end surface D2 that is disposed opposite the chip end surface D1 of the optical device 100.

The adiabatic conversion unit 103B is constituted such that the second tapered waveguide 102A is arranged, between the two fourth tapered waveguides 101E, below the two fourth tapered waveguides 101E in a state in which the second tapered waveguide 102A is away from the two fourth tapered waveguides 101E. In addition, the gap between each of the two fourth tapered waveguides 101E and the second tapered waveguide 102A is set to be constant. In the adiabatic conversion unit 103B, the second tapered waveguide 102A is arranged between the two fourth tapered waveguides 101E. In addition, the mode field is present across a portion that is located mainly around the two fourth tapered waveguides 101E even if the SiN waveguide 101 is not located directly above the Si waveguide 102, so that light is adiabatically transitioned from the SiN waveguide 101 to the Si waveguide 102.

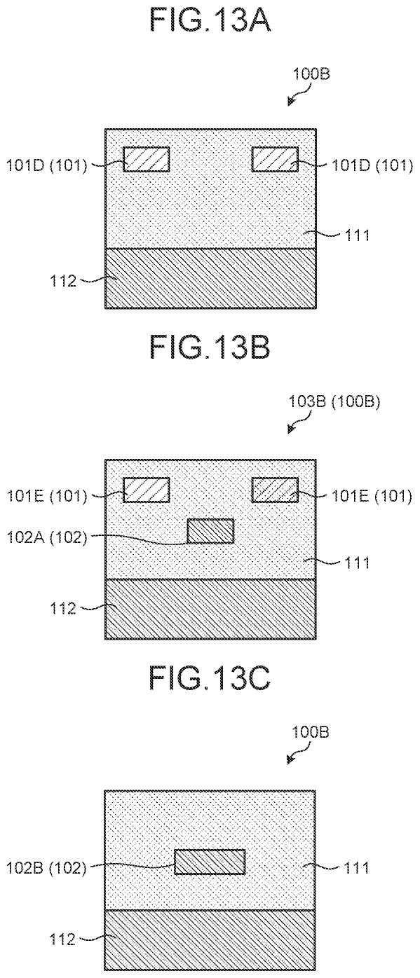

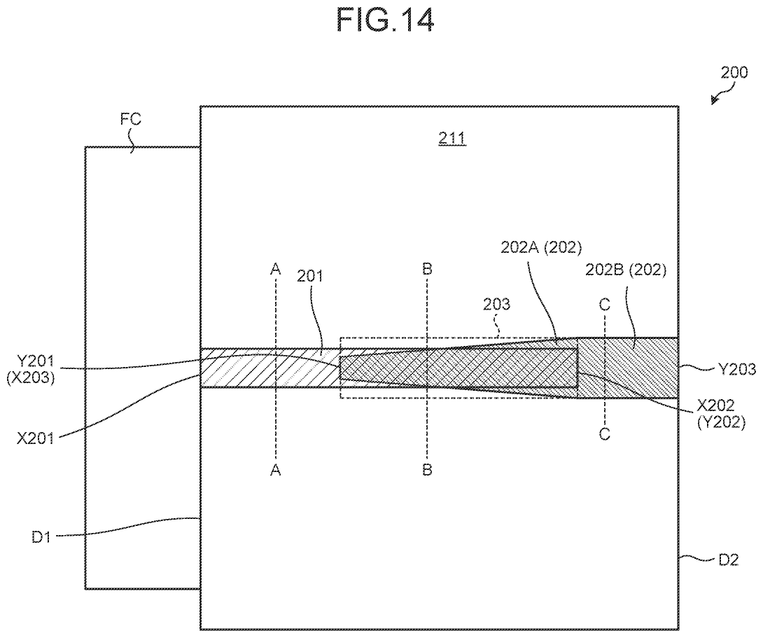

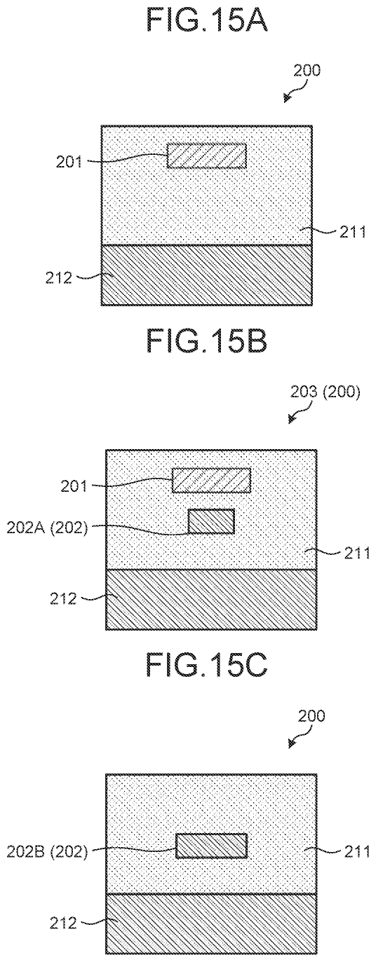

The adiabatic conversion unit 103B includes the start point X102 (Y101), the end point X103 (Y102), and an intermediate portion that is located between the start point and the end point. FIG. 13A is a diagram illustrating one example of the schematic cross-sectional portion taken along line A-A illustrated in FIG. 12. The schematic cross-sectional portion taken along the line A-A illustrated in FIG. 13A is a cross-sectional part of the optical device 100B in which the two third tapered waveguides 101D included in the SiN waveguide 101 are arranged. The optical device 100B includes the Si substrate 112, the clad 111 that is laminated on the Si substrate 112, and the two third tapered waveguides 101D that are arranged in the interior of the clad 111.

FIG. 13B is a diagram illustrating one example of a schematic cross-sectional portion taken along line B-B illustrated in FIG. 12. The schematic cross-sectional portion taken along the line B-B illustrated in FIG. 13B is a cross-sectional part of the optical device 100B in which the adiabatic conversion unit 103B is arranged. The optical device 100B includes the Si substrate 112, the clad 111 that is laminated on the Si substrate 112, the two fourth tapered waveguides 101E that are arranged in the interior of the clad 111, and the second tapered waveguide 102A that is arranged in the interior of the clad 111. The adiabatic conversion unit 103B has a structure in which the second tapered waveguide 102A is disposed, between the two fourth tapered waveguides 101E, side by side the two fourth tapered waveguides 101E at the position below the two fourth tapered waveguides 101E. The gap between each of the two fourth tapered waveguides 101E and the second tapered waveguide 102A is set to be constant.

FIG. 13C is a diagram illustrating one example of a schematic cross-sectional portion taken along line C-C illustrated in FIG. 12. The schematic cross-sectional portion taken along the line C-C illustrated in FIG. 13C is a cross-sectional part of the optical device 100B in which the second straight line waveguide 102B included in the Si waveguide 102 is arranged. The optical device 100B includes the Si substrate 112, the clad 111 that is laminated on the Si substrate 112, and the second straight line waveguide 102B that is arranged in the interior of the clad 111.

In the optical device 100B according to the comparative example 3, the waveguide width of the two third tapered waveguides 101D included in the SiN waveguide 101 is made gradually wider, so that it is possible to strongly confine light. As a result, a radiation loss at the leading end of the Si waveguide 3 at the start point of an adiabatic conversion unit 4 is decreased, so that it is possible to reduce the length of the adiabatic conversion unit 103B. However, if the confinement of the SiN waveguide 101 remains strong, the conversion efficiency of the adiabatic conversion unit 103B varies in accordance with a wavelength or polarization, so that the dependence property of the wavelength and the polarization with respect to the conversion efficiency is increased.

Accordingly, in the adiabatic conversion unit 103B included in the optical device 100B, the waveguide width of the two fourth tapered waveguides 101E included in the SiN waveguide 101 are made gradually narrower, it is possible to reduce the dependence property of the wavelength and the polarization with respect to the conversion efficiency.

However, in the optical device 100B according to the comparative example 3, in order to gradually narrow the waveguide width of the two third tapered waveguides 101D included in the SiN waveguide 101, the structure is constituted such that the gap between the start point of each of the two third tapered waveguides 101D that are optically coupled to the core FC included in the optical fiber become narrow. As a result, the mode field of the optical device 100B at the chip end surface D1 is small, and the mode field of the core FC included in the optical fiber is large, so that the coupling efficiency of the optical device 100B with the core FC included in the optical fiber is degraded.

Accordingly, embodiments of an optical device 1 that resolves the above described circumstances will be explained in detail below with reference to the accompanying drawings. Furthermore, the present invention is not limited to the embodiments. In addition, the embodiments described below may also be used in any appropriate combination as long as the embodiments do not conflict with each other.

### <a> First Embodiment

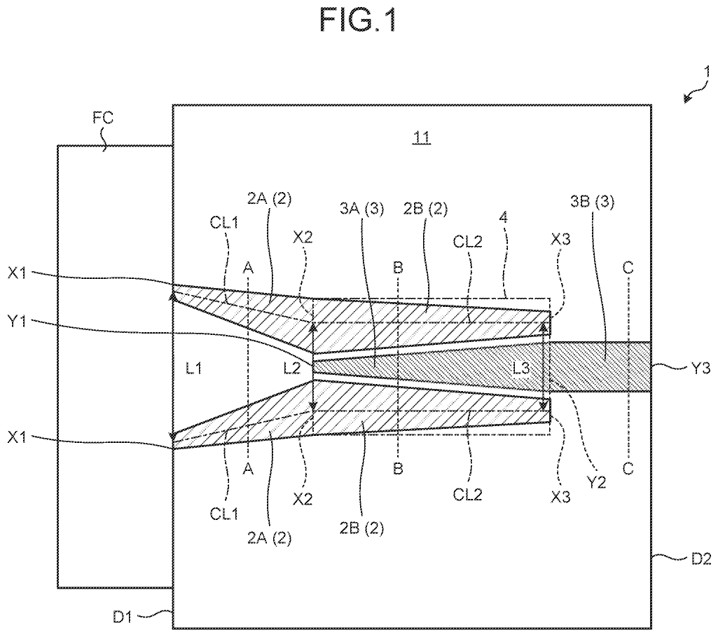

FIG. 1 is a diagram illustrating one example of the optical device 1 according to the first embodiment. The optical device 1 illustrated in FIG. 1 is an optical chip in which the substrate type optical waveguide element that is optically coupled to the core FC included in the optical fiber is built in. The optical device 1 includes a silicon nitride (SiN) waveguide 2, a silicon (Si) waveguide 3, and a clad 11 that covers the Si waveguide 3 and the SiN waveguide 2. The optical device 1 includes the adiabatic conversion unit 4 in which light is transitioned at a portion between the Si waveguide 3 and the SiN waveguide 2 on the basis of an adiabatic indirect transition.

The SiN waveguide 2 is a first waveguide made of, for example, Si₃N₄ (hereinafter, simply referred to as SiN). The material refractive index of SiN in the case where the optical wavelength is 1.55 μm is 1.99. The Si waveguide 3 is a second waveguide made of, for example, Si. The material refractive index of Si in the case where the optical wavelength is 1.55 μm is 3.48. The material refractive index of Si is a second material refractive index. The material refractive index of SiN is smaller than the material refractive index of Si. The clad 11 is a layer made of, for example, SiO₂. The material refractive index of SiO₂ in the case where the optical wavelength is 1.55 μm is 1.44.

The SiN waveguide 2 includes two first tapered waveguides 2A and two second tapered waveguides 2B that are optically coupled to the respective two first tapered waveguides 2A. Each of the first tapered waveguides 2A is a waveguide having a tapered structure in which the waveguide width is gradually wider from a start point X1 toward the end point X2. In other words, the first tapered waveguide 2A has a structure in which the waveguide width is gradually wider toward the second tapered waveguide. Each of the second tapered waveguides 2B is a waveguide having a tapered structure in which the waveguide width is gradually narrower from a start point X2 toward the end point X3. In other words, each of the second tapered waveguides 2B has a structure in which the waveguide width is gradually narrower as the second tapered waveguide 2B is farther away from the associated first tapered waveguide 2A. As a result of the end point X2 of the first tapered waveguides 2A being optically coupled to the start point X2 of the respective second tapered waveguides 2B, a portion between each of the first tapered waveguides 2A and the associated second tapered waveguide 2B is optically coupled. The thickness of the core of the first tapered waveguide 2A is set to be the same as that of the second tapered waveguide 2B. The start point X1 of the SiN waveguide 2 starts from the chip end surface D1 of the optical device 1 that is optically coupled to the core FC included in the optical fiber.

A line connecting between the core center of each of the first tapered waveguides 2A at the associated start point X1 and the core center of each of the first tapered waveguides 2A at the associated end point X2 is denoted by a first center line CL1. In addition, the end point X2 of each of the first tapered waveguides 2A and the start point X2 of the associated second tapered waveguides 2B are the same. A line connecting between the core center of each of the second tapered waveguides 2B at the start point X2 and the core center of the associated second tapered waveguides 2B at the end point X3 is denoted by a second center line CL2.

In addition, a distance between the core center at the start point X1 of one of the first tapered waveguides 2A and the core center at the start point X1 of the other of the first tapered waveguides 2A is denoted by a first gap L1. In other words, the first gap L1 is a gap between the first tapered waveguides 2A at the respective start points X1. A distance between the core center at the end point X2 of one of the first tapered waveguides 2A and the core center at the end point X2 of the other of the first tapered waveguides 2A is denoted by a second gap L2. In other words, the second gap L2 is a gap between the two first waveguides 2 at the connection portion between each of the first tapered waveguides 2A and the associated second tapered waveguide 2B. A distance between the core center at the end point X3 of one of the second tapered waveguides 2B and the core center at the end point X3 of the other of the second tapered waveguides 2B is denoted by a third gap L3. Then, L1>L2, L1>L3, and L2=L3 hold with respect to the relationship among the first gap L1, the second gap L2, and the third gap L3. In other words, the first waveguide 2 is a structure in which the first gap L1 is larger than the second gap L2.

The optical device 1 has a structure constituted such that the distance between the two first tapered waveguides 2A is defined as the first gap L1 in order to widen a portion of the SiN waveguide 2 that is located at the chip end surface D1 and that is optically coupled to the core FC included in the optical fiber and in order to make the mode field of the optical device 1 closer to the mode field of the core FC included in the optical fiber. Consequently, as a result of the mode field of the optical device 1 at the chip end surface D1 being closer to the mode field of the core FC included in the optical fiber, the coupling efficiency of the optical device 1 with the core FC included in the optical fiber is improved.

The Si waveguide 3 includes a third tapered waveguide 3A and a straight line waveguide 3B that is optically coupled to the third tapered waveguide 3A. The third tapered waveguide 3A is a waveguide having a tapered structure in which the waveguide width is gradually wider from a start point Y1 toward an end point Y2. In other words, the third tapered waveguide 3A has a structure in which the waveguide width is gradually wider as the third tapered waveguide 3A is closer to the straight line waveguide 3B that is the third waveguide. The straight line waveguide 3B is a waveguide in which the waveguide width is constant from a start point Y2 toward an end point Y3. In other words, the straight line waveguide 3B is a waveguide that is connected to the third tapered waveguide 3A on a side opposite to the side on which the first tapered waveguides 2A are provided. The thickness of the core of the third tapered waveguide 3A is set to be the same as that of the straight line waveguide 3B. The end point Y3 of the straight line waveguide 3B included in the Si waveguide 3 ends at the chip end surface D2 that is disposed opposite the chip end surface D1 of the optical device 1.

The adiabatic conversion unit 4 includes the two second tapered waveguides 2B included in the SiN waveguide 2, and the third tapered waveguide 3A included in the Si waveguide 3. The adiabatic conversion unit 4 is constituted such that the third tapered waveguide 3A is arranged, between the two second tapered waveguides 2B, side by side with the two second tapered waveguides 2B at the position below the second tapered waveguides 2B in a state in which the third tapered waveguide 3A is away from the second tapered waveguides 2B. In addition, the gap between each of the second tapered waveguides 2B and the third tapered waveguide 3A is set to be constant. In the adiabatic conversion unit 4, the third tapered waveguide 3A is arranged between the two second tapered waveguides 2B. In addition, the mode field is present across a portion that is located mainly around the two second tapered waveguides 2B even if the SiN waveguide 2 is not located directly above the Si waveguide 3, so that light is adiabatically transitioned from the SiN waveguide 2 to the Si waveguide 3.

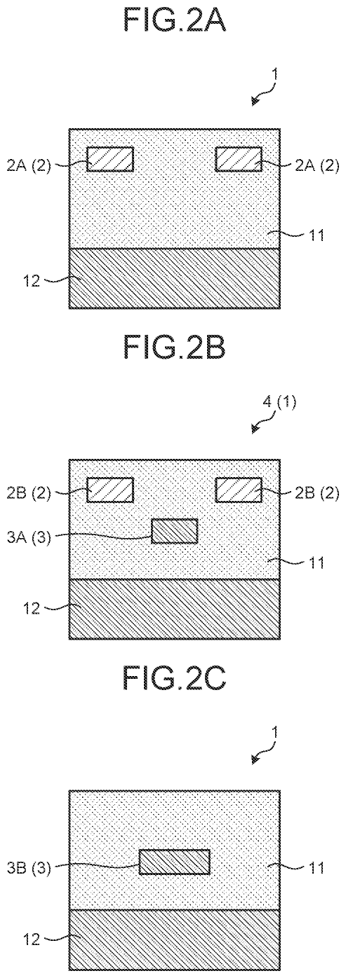

The adiabatic conversion unit 4 includes the start point X2 (Y1), the end point X3 (Y2), and an intermediate portion that is located between the start point and the end point. FIG. 2A is a diagram illustrating one example of a schematic cross-sectional portion taken along line A-A illustrated in FIG. 1. The schematic cross-sectional portion taken along the line A-A illustrated in FIG. 2A is a cross-sectional part of the optical device 1 in which the two first tapered waveguides 2A included in the SiN waveguide 2 are arranged. The optical device 1 includes a Si substrate 12, the clad 11 that is laminated on the Si substrate 12, and the two first tapered waveguides 2A that are arranged in the interior of the clad 11.

FIG. 2B is a diagram illustrating one example of a schematic cross-sectional portion taken along line B-B illustrated in FIG. 1. The schematic cross-sectional portion taken along the line B-B illustrated in FIG. 2B is a cross-sectional part of the optical device 1 in which the adiabatic conversion unit 4 is arranged. The optical device 1 includes the Si substrate 12, the clad 11 that is laminated on the Si substrate 12, the two second tapered waveguides 2B that are arranged in the interior of the clad 11, and the third tapered waveguide 3A that is arranged in the interior of the clad 11. The adiabatic conversion unit 4 has a structure in which the third tapered waveguide 3A is disposed, between the two second tapered waveguides 2B, side by side with (parallel to) the two second tapered waveguides 2B at the position below the two second tapered waveguides 2B. The gap between each of the second tapered waveguide 2B and the third tapered waveguide 3A is constant.

FIG. 2C is a diagram illustrating one example of a schematic cross-sectional portion taken along line C-C illustrated in FIG. 1. The schematic cross-sectional portion taken along the line C-C illustrated in FIG. 2C is a cross-sectional part of the optical device 1 in which the straight line waveguide 3B included in the Si waveguide 3 is arranged. The optical device 1 includes the Si substrate 12, the clad 11 that is laminated on the Si substrate 12, and the straight line waveguide 3B that is arranged in the interior of the clad 11.

The start point of the adiabatic conversion unit 4 is a portion in which the start point X2 of each of the second tapered waveguides 2B and the start point Y1 of the third tapered waveguide 3A are arranged. The waveguide width of the second tapered waveguides 2B at the start point X2 is made wider than the waveguide width of the third tapered waveguide 3A at the start point Y1. The adiabatic conversion unit 4 has a structure in which the third tapered waveguide 3A is disposed, between the two second tapered waveguides 2B, side by side with the two second tapered waveguides 2B at the position below the two second tapered waveguides 2B.

The end point of the adiabatic conversion unit 4 is a portion in which the end point X3 of each of the second tapered waveguides 2B and the end point Y2 of the third tapered waveguide 3A are arranged. The waveguide width of each of the second tapered waveguides 2B at the associated end point X3 is made narrower than the waveguide width of the third tapered waveguide 3A at the end point Y3.

In the adiabatic conversion unit 4 included in the optical device 1 according to the first embodiment, the third tapered waveguide 3A is arranged between the two second tapered waveguides 2B, so that light is adiabatically transitioned between the second tapered waveguide 2B and the third tapered waveguide 3A. As a result, a discontinuous portion is not present in the SiN waveguide 2, so that it is possible to suppress an occurrence of a radiation loss or a reflection loss of light.

In the optical device 1, the waveguide width of the two first tapered waveguides 2A included in the SiN waveguide 2 is made gradually wider, so that it is possible to strongly confine light. As a result, a radiation loss at the leading end of the Si waveguide 3 at the start point of the adiabatic conversion unit 4 is decreased, so that it is possible to reduce the length of the adiabatic conversion unit 4.

In addition, in the optical device 1, the waveguide width of the two second tapered waveguides 2B included in the SiN waveguide 2 is made gradually narrower, so that it is possible to suppress a decrease in the conversion efficiency while decreasing the dependence property of the wavelength and the polarization with respect to the conversion efficiency as a result of a reduction in the effective refractive index of the SiN waveguide 2.

In addition, the optical device 1 constituted to have a structure in which the gap between the two first tapered waveguides 2A is changed so as to be gradually narrower from the start point X1 toward the end point X2. In the optical device 1, the portion of the SiN waveguide 2 that is located at the chip end surface D1 and that is optically coupled to the core FC included in the optical fiber is made wider, and the first gap L1 is made larger than the second gap L2. Consequently, it is possible to improve the coupling efficiency with the core FC included in the optical fiber in the optical device 1 as a result of the mode field of the optical device 1 at the chip end surface D1 being closer to the mode field of the core FC included in the optical fiber.

In addition, in the optical device 1 according to the first embodiment, the relationship between the second gap L2 and the third gap L3 is L2=L3, so that the mode field of the adiabatic conversion unit 4 is wide, and thus, it is not possible to make the mode field of the adiabatic conversion unit 4 to be closer to the mode field of the straight line waveguide 3B that is included in the Si waveguide 3 and that is optically coupled to the adiabatic conversion unit 4. As a result, a coupling loss occurs due to a mismatch of the mode field with the Si waveguide 3 at the adiabatic conversion unit 4. Accordingly, an embodiment of solving this circumstance will be described below as a second embodiment.

### <b> Second Embodiment

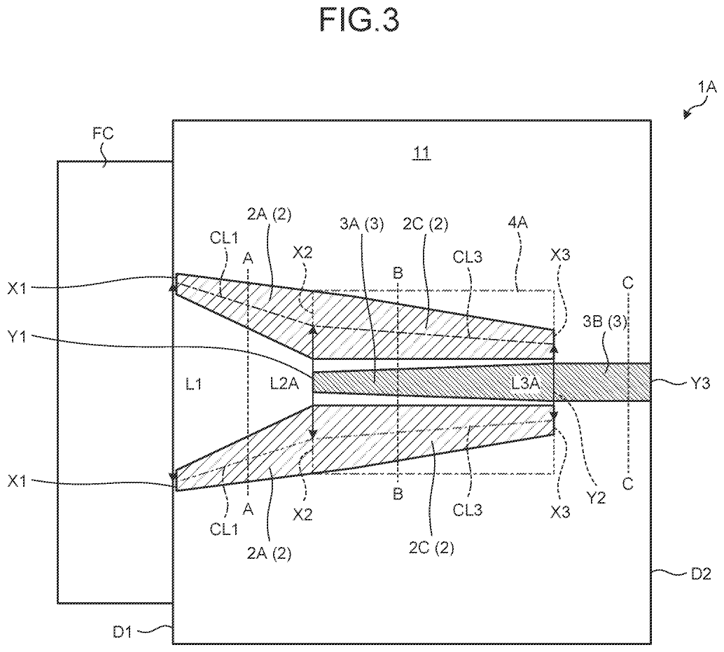

FIG. 3 is a diagram illustrating one example of an optical device 1A according to the second embodiment. In addition, by assigning the same reference numerals to components having the same configuration as those in the optical device 1 according to the first embodiment, overlapped descriptions of the configuration and the operation thereof will be omitted. The optical device 1A according to the second embodiment is different from the optical device 1 according to the first embodiment in that the second gap L2 located at the start point X2 (Y1) of an adiabatic conversion unit 4A is made narrower than the third gap L3 located at the end point X3 (Y2) of the adiabatic conversion unit 4A.

The SiN waveguide 2 includes the two first tapered waveguides 2A and two second tapered waveguides 2C. Each of the second tapered waveguides 2C is a waveguide having a tapered structure in which the waveguide width is gradually narrower from the start point X2 toward the end point X3. A line connecting between the core center of each of the first tapered waveguides 2A at the associated start point X1 and the core center of each of the first tapered waveguides 2A at the associated end point X2 is denoted by the first center line CL1. A line connecting between the core center of each of the second tapered waveguides 2C at the associated start point X2 and the core center of each of the second tapered waveguides 2C at the associated end point X3 is denoted by the third center line CL3.

A distance between the core center at the end point X2 of one of the first tapered waveguides 2A and the core center at the end point X2 of the other of the first tapered waveguides 2A is denoted by a second gap L2A. A distance between the core center at the end point X3 of one of the second tapered waveguides 2C and the core center at the end point X3 of the other of second tapered waveguides 2C is denoted by a third gap L3A. Then, the relationship among the first gap L1, L1>L2A, L1>L3A, and L2A>L3A hold with respect to the second gap L2A, and the third gap L3A.

The optical device 1A has a structure constituted such that the distance between the two first tapered waveguides 2A is defined as the first gap L1 in order to widen a portion of the SiN waveguide 2 that is located at the chip end surface D1 and that is optically coupled to the core FC of the optical fiber and in order to make the mode field of the optical device 1 closer to the mode field of the core FC included in the optical fiber. As a result, as a result of the mode field of the optical device 1 at the chip end surface D1 being closer to the mode field of the core FC included in the optical fiber, the coupling efficiency of the optical device 1 with the core FC included in the optical fiber is improved.

In the adiabatic conversion unit 4A, the two second tapered waveguides 2C are constituted such that the third gap L3A is narrower than the second gap L2A. As a result, the mode field of the adiabatic conversion unit 4A is closer to the mode field of the straight line waveguide 3B included in the Si waveguide 3, so that it is possible to suppress the coupling loss with the Si waveguide 3 occurring in the adiabatic conversion unit 4A.

The adiabatic conversion unit 4A includes the two second tapered waveguides 2C included in the SiN waveguide 2, and the third tapered waveguide 3A included in the Si waveguide 3. The adiabatic conversion unit 4A is constituted such that the third tapered waveguide 3A is arranged, between the two second tapered waveguides 2C, side by side with the second tapered waveguides 2C at the position below the second tapered waveguides 2C in a state in which the third tapered waveguide 3A is away from the second tapered waveguides 2C. In addition, the gap between each of the second tapered waveguide 2C and the third tapered waveguide 3A is set to be constant.

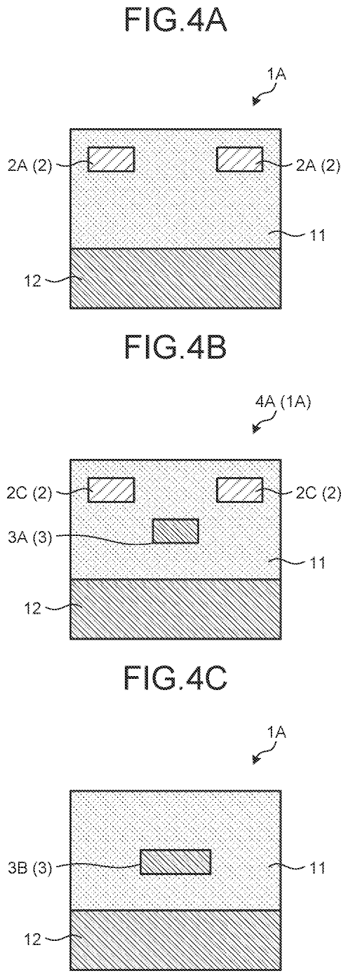

The adiabatic conversion unit 4A includes the start point X2 (Y1), the end point X3 (Y2), and an intermediate portion that is located between the start point and the end point. FIG. 4A is a diagram illustrating one example of a schematic cross-sectional portion taken along line A-A illustrated in FIG. 3. The schematic cross-sectional portion taken along the line A-A illustrated in FIG. 4A is a cross-sectional part of the optical device 1A in which the two first tapered waveguides 2A included in the SiN waveguide 2 are arranged. The optical device 1A includes the Si substrate 12, the clad 11 that is laminated on the Si substrate 12, and the two first tapered waveguides 2A that are disposed in the interior of the clad 11.

FIG. 4B is a diagram illustrating one example of a schematic cross-sectional portion taken along line B-B illustrated in FIG. 3. The schematic cross-sectional portion taken along the line B-B illustrated in FIG. 4B is a cross-sectional part of the optical device 1A in which the adiabatic conversion unit 4A is arranged. The optical device 1A includes the Si substrate 12, the clad 11 that is laminated on the Si substrate 12, the two second tapered waveguides 2C that are arranged in the interior of the clad 11, and the third tapered waveguide 3A that is arranged in the interior of the clad 11. The adiabatic conversion unit 4A has a structure in which the third tapered waveguide 3A is disposed, between the two second tapered waveguides 2C, side by side with the two second tapered waveguides 2C at the position below the second tapered waveguides 2C. The gap between each of the second tapered waveguides 2C and the third tapered waveguide 3A is set to be constant.

FIG. 4C is a diagram illustrating one example of a schematic cross-sectional portion taken along line C-C illustrated in FIG. 3. The schematic cross-sectional portion taken along line the C-C illustrated in FIG. 4C is a cross-sectional part of the optical device 1A in which the straight line waveguide 3B included in the Si waveguide 3 is arranged. The optical device 1A includes the Si substrate 12, the clad 11 that is laminated on the Si substrate 12, and the straight line waveguide 3B that is arranged in the interior of the clad 11.

The start point of the adiabatic conversion unit 4A is a portion in which the start point X2 of each of the second tapered waveguides 2C and the start point Y1 of the third tapered waveguide 3A are arranged. The waveguide width of each of the second tapered waveguides 2C at the start point X2 is made wider than the waveguide width of the third tapered waveguide 3A at the start point Y1. The adiabatic conversion unit 4A has a structure in which the third tapered waveguide 3A is disposed, between the two second tapered waveguides 2C, side by side with the two second tapered waveguides 2C at the position below the two second tapered waveguides 2C. The end point of the adiabatic conversion unit 4A is a portion in which the end point X3 of each of the second tapered waveguides 2C and the end point Y2 of the third tapered waveguide 3A are arranged.

The adiabatic conversion unit 4A included in the optical device 1A according to the second embodiment is constituted to have a structure in which the gap between the second tapered waveguides 2C is gradually narrower such that the third gap L3A at the end points of both of the two second tapered waveguides 2C is narrower than the second gap L2A at the start points of both of the second tapered waveguides 2C. As a result, the mode field of the adiabatic conversion unit 4A is closer to the mode field of the straight line waveguide 3B while suppressing a decrease in conversion efficiency at the adiabatic conversion unit 4A, so that it is possible to improve the coupling loss with the Si waveguide 3.

In the adiabatic conversion unit 4A, the effective refractive index is controlled by changing the SiN waveguide 2 in a tapered manner, the gap between the second tapered waveguides 2C is made gradually narrower, so that the mode field of light propagating through the SiN waveguide 2 is controlled. The effective refractive index and the mode field of the light propagating through the SiN waveguide 2 are made closer to the effective refractive index and the mode field of the light propagating through the Si waveguide 3. As a result, it is possible to shorten the length of the adiabatic conversion unit 4A while decreasing the coupling loss between the SiN waveguide 2 and the Si waveguide 3.

In addition, in the adiabatic conversion unit 4A included in the optical device 1A according to the second embodiment, the end point X3 of each of the second tapered waveguides 2C included in the SiN waveguide 2 is terminated in a state closer to the Si waveguide 3, so that the refractive index distribution of light is sharply changed as a result of the SiN waveguide 2 being terminated at the end point of the adiabatic conversion unit 4A. Consequently, a scattering loss of light occurs caused by a change in a cross-sectional shape at the end point of the adiabatic conversion unit 4A. Accordingly, in order to cope with the circumstances, an embodiment thereof will be described below as a third embodiment.

### <c> Third Embodiment

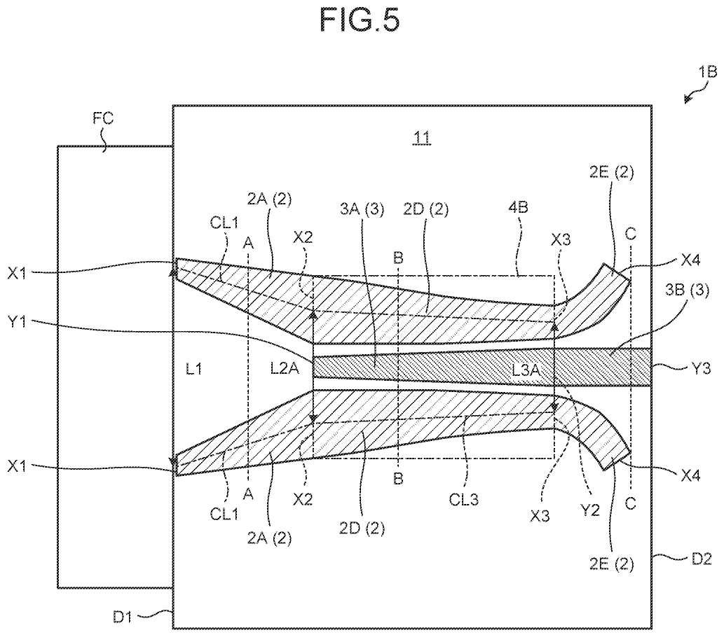

FIG. 5 is a diagram illustrating one example of an optical device 1B according to the third embodiment. In addition, by assigning the same reference numerals to components having the same configuration as those in the optical device 1A according to the second. The optical device 1B according to the third embodiment is different from the optical device 1A according to the second embodiment in that a terminal end of a second tapered waveguide 2D included in the SiN waveguide 2 at the end point X3 (Y2) of an adiabatic conversion unit 4B is gradually away from the Si waveguide 3.

The SiN waveguide 2 includes the two first tapered waveguides 2A, the two second tapered waveguides 2D, and two bent waveguides 2E. Each of the second tapered waveguides 2D is a waveguide that has a tapered structure in which the waveguide width is gradually narrower from the start point X2 toward the end point X3. Each of the bent waveguides 2E is a waveguide that is bent from the start point X3 toward the end point X4 so as to be gradually away from the Si waveguide 3.

A line connecting between the core center of each of the first tapered waveguides 2A at the associated start point X1 and the core center of each of the first tapered waveguides 2A at the associated end point X2 is denoted by the first center line CL1. A line connecting between the core center of each of the second tapered waveguides 2D at the associated start point X2 and the core center of each of the second tapered waveguides 2D at the associated end point X3 is denoted by the third center line CL3.

A distance between the core center at the end point X2 of one of the first tapered waveguides 2A and the core center at the end point X2 of the other of the first tapered waveguides 2A is denoted by the second gap L2A. A distance between the core center at the end point X3 of one of the second tapered waveguides 2D and the core center at the end point X3 of the other of the second tapered waveguides 2D is denoted by the third gap L3A. Then, L1>L2A, L1>L3A, and L2A>L3A hold with respect to the relationship among the first gap L1, the second gap L2A, and the third gap L3A.

The optical device 1B has a structure constituted such that the distance between the two first tapered waveguides 2A is defined as the first gap L1 in order to widen a portion of the SiN waveguide 2 that is located at the chip end surface D1 and that is optically coupled to the core FC of the optical fiber and in order to make the mode field of the optical device 1 closer to the mode field of the core FC included in the optical fiber. As a result, as a result of the mode field of the optical device 1 at the chip end surface D1 being closer to the mode field of the core FC included in the optical fiber, the coupling efficiency of the optical device 1 with the core FC included in the optical fiber is improved.

In the adiabatic conversion unit 4B, the two second tapered waveguides 2D are constituted such that the third gap L3A is narrower than the second gap L2A. As a result, the mode field of the adiabatic conversion unit 4B is closer to the mode field of the straight line waveguide 3B included in the Si waveguide 3, so that it is possible to suppress the coupling loss with the Si waveguide 3 occurring in the adiabatic conversion unit 4B.

The adiabatic conversion unit 4B includes the two second tapered waveguides 2D included in the SiN waveguide 2, and the third tapered waveguide 3A included in the Si waveguide 3. The adiabatic conversion unit 4B is constituted such that the third tapered waveguide 3A is arranged, between the two second tapered waveguides 2D, side by side with the second tapered waveguides 2D at the position below the second tapered waveguides 2D in a state in which the third tapered waveguide 3A is away from the second tapered waveguides 2D. In addition, the gap between each of the second tapered waveguides 2D and the third tapered waveguide 3A is set to be constant.

In addition, each of the bent waveguides 2E that is optically coupled to the end point X3 of the associated second tapered waveguides 2D is constituted such that the terminal end of the SiN waveguide 2 is gradually away from the straight line waveguide 3B included in the Si waveguide 3.

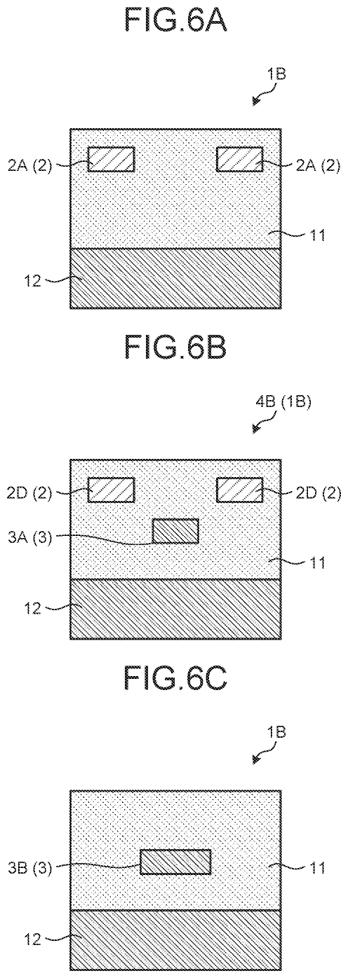

The adiabatic conversion unit 4B includes the start point X2 (Y1), the end point X3 (Y2), and the intermediate portion that is located between the start point and the end point. FIG. 6A is a diagram illustrating one example of a schematic cross-sectional portion taken along line A-A illustrated in FIG. 5. The schematic cross-sectional portion taken along the line A-A illustrated in FIG. 6A is a cross-sectional part of the optical device 1B in which the two first tapered waveguides 2A included in the SiN waveguide 2 are arranged. The optical device 1B includes the Si substrate 12, the clad 11 that is laminated on the Si substrate 12, and the two first tapered waveguides 2A that are arranged in the interior of the clad 11.

FIG. 6B is a diagram illustrating one example of a schematic cross-sectional portion taken along line B-B illustrated in FIG. 5. The schematic cross-sectional portion taken along the line B-B illustrated in FIG. 6B is a cross-sectional part of the optical device 1B in which the adiabatic conversion unit 4B is arranged. The optical device 1B includes the Si substrate 12, the clad 11 that is laminated on the Si substrate 12, the two second tapered waveguides 2D that are arranged in the interior of the clad 11, and the third tapered waveguide 3A that is arranged in the interior of the clad 11. The adiabatic conversion unit 4B has a structure in which the third tapered waveguide 3A is disposed, between the two second tapered waveguides 2D, side by side with the two second tapered waveguides 2D at the position below the two second tapered waveguides 2D. The gap between each of the second tapered waveguides 2D and the third tapered waveguide 3A is set to be constant.

FIG. 6C is a diagram illustrating one example of a schematic cross-sectional portion taken along line C-C illustrated in FIG. 5. The schematic cross-sectional portion taken along the line C-C illustrated in FIG. 6C is a cross-sectional part of the optical device 1B in which the straight line waveguide 3B included in the Si waveguide 3 is arranged. The optical device 1B includes the Si substrate 12, the clad 11 that is laminated on the Si substrate 12, and the straight line waveguide 3B that is arranged in the interior of the clad 11.

The start point of the adiabatic conversion unit 4B is a portion in which the start point X2 of each of the second tapered waveguides 2D and the start point Y1 of the third tapered waveguide 3A are arranged. The waveguide width of each of the second tapered waveguides 2D at the start point X2 is made wider than the waveguide width of the third tapered waveguide 3A at the start point Y1. The adiabatic conversion unit 4B has a structure in which the third tapered waveguide 3A is disposed, between the two second tapered waveguides 2D, side by side with the two second tapered waveguides 2D at the position below the two second tapered waveguides 2D. The end point of the adiabatic conversion unit 4B is a portion in which the end point X3 of each of the second tapered waveguides 2D and the end point Y2 of the third tapered waveguide 3A are arranged.

In the optical device 1B according to the third embodiment, each of the bent waveguides 2E is optical coupled to the end point X3 of the associated second tapered waveguides 2D included in the adiabatic conversion unit 4B in a manner such that each of the bent waveguides 2E is gradually away from the straight line waveguide 3B included in the Si waveguide 3. As a result, the terminal end of the SiN waveguide 2 is gradually away from the Si waveguide 3 at the end point of the adiabatic conversion unit 4B, so that it is possible to suppress a scattering loss of light as a result of the refractive index distribution of light being slowly changed.

In addition, in the embodiment, the second tapered waveguides 2B and the third tapered waveguide 3A included in the adiabatic conversion unit 4 (4A, 4B) may be a Planar Lightwave Circuit (PLC) in which both of the core and the clad are made of SiO₂, or may be an InP waveguide or a GaAs waveguide. The core may be made of Si or Si₃N₄, a lower part clad may be made of SiO₂, and an upper part clad may be made of SiO₂ or may be air or the like. In addition, this may be applicable in the case where the material refractive index of the waveguide provided at the transition destination is higher than the material refractive index of the waveguide provided at the transition source. For example, in a case of the PLC, it is also applicable by changing the material refractive index at the transition source and the transition destination by changing an amount of doping into a glass waveguide.

In addition, the SiN waveguide 2 has been exemplified as the first waveguide, the Si waveguide 3 has been exemplified as the second waveguide, and SiO₂ has been exemplified as the clad. However, the refractive index of the material of the clad may be set to be smaller than the refractive index of the material of the first waveguide, and the refractive index of the material of the first waveguide may be set to be smaller than the refractive index of the material of the second waveguide, so that the materials of the first waveguide, the second waveguide, and the clad may appropriately be changed.

In the case of the PLC, it is possible to change the material refractive index by changing an amount of doping into the core. In the case of the SiN waveguide 2 and the Si waveguide 3, the relative refractive index difference is large, so that light is strongly confined, and, as a result, it is possible to implement a bent waveguide having a low loss even if a radius R is small, and it is thus possible to reduce the size of the optical device 1.

The structure of each of the SiN waveguide 2 and the Si waveguide 3 may be a rib waveguide, a ridge waveguide, or a channel waveguide, and appropriate modifications are possible. If the structure of each of the SiN waveguide 2 and the Si waveguide 3 is a rib waveguide, light is also leaked to a slab portion, the effect of the rough side walls of the core is small, and it is possible to suppress an optical loss. If the structure of the SiN waveguide 2 and the Si waveguide 3 is a channel waveguide, confinement of light is strong, so that it is possible to sharply bend the waveguide, and it is thus possible to reduce the size of the optical device 1. The clad 11 may be made of an arbitrary material as long as the material refractive index is smaller than that of the core, and appropriate modifications are possible.

A case has been described as an example in which the optical device 1 (1A, 1B) according to the present embodiment is a silicon optical waveguide formed by using Si as the material of the Si waveguide 3 and SiO₂ as the material of the clad 11. However, it is also applicable to a PLC, an InP waveguide, and a GaAs waveguide in which the material of each of the Si waveguide 3 and the clad 11 is SiO₂.

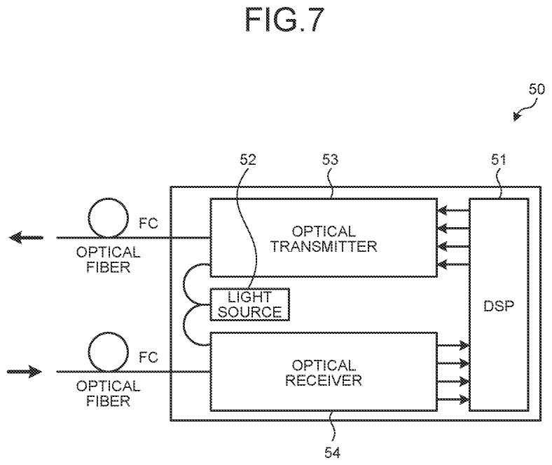

FIG. 7 is a diagram illustrating one example of an optical communication apparatus 50 having the optical device 1 (1A, 1B) according to the present embodiment built in. The optical communication apparatus 50 illustrated in FIG. 7 is connected to an optical fiber disposed on an output side and an optical fiber disposed on an input side. The optical communication apparatus 50 includes a digital signal processor (DSP) 51, a light source 52, an optical transmitter 53, and an optical receiver 54. The DSP 51 is an electrical component that performs digital signal processing. The DSP 51 performs a process of, for example, encoding transmission data or the like, generating an electrical signal including transmission data, and outputs the generated electrical signal to the optical transmitter 53. Furthermore, the DSP 51 acquires an electrical signal including reception data from the optical receiver 54 and obtains reception data by performing a process of, for example, decoding the acquired electrical signal.

The light source 52 includes, for example, a laser diode or the like, generates light with a predetermined wavelength, and supplies the generated light to the optical transmitter 53 and the optical receiver 54. The optical transmitter 53 modulates, by using the electrical signal output from the DSP 51, the light supplied from the light source 52, and outputs the obtained transmission light to the optical fiber. The optical transmitter 53 generates the transmission light by modulating, when the light supplied from the light source 52 propagates through the waveguide, the light by using the electrical signal that is input to the optical modulator.

The optical receiver 54 receives the optical signal from the optical fiber and demodulates the received light by using the light that is supplied from the light source 52. Then, the optical receiver 54 converts the demodulated received light to an electrical signal and outputs the converted electrical signal to the DSP 51. In the optical transmitter 53 and the optical receiver 54, the optical device 1 (1A, 1B) corresponding to the substrate type optical waveguide element functioning as a waveguide through which light is propagated is installed as a built in device.

In the adiabatic conversion unit 4 (4A, 4B) included in the optical device 1 (1A, 1B) in the optical communication apparatus 5, the mode field of the optical device 1 at the chip end surface D1 is closer to the mode field of the core FC included in the optical fiber, so that it is possible to improve the coupling efficiency of the optical device 1 with the core FC included in the optical fiber.

In addition, for convenience of description, a case has been described as an example in which the optical communication apparatus 50 includes the optical transmitter 53 and the optical receiver 54 as the built in units; however the optical communication apparatus 50 may include one of the optical transmitter 53 and the optical receiver 54 as the built in unit. For example, the optical device 1 may be applied to the optical communication apparatus 50 having the optical transmitter 53 built in, or the optical communication apparatus 50 having the optical receiver 54 built in, and appropriate modifications are possible.

According to an aspect of an embodiment, it is possible to suppress a coupling loss between the first waveguide and the optical fiber that is optically coupled to the first waveguide.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
two first waveguides that are arranged side by side on a substrate; and
a single second waveguide that is arranged, on the substrate, so as to be side by side with and away from the first waveguides, wherein
each of the first waveguides includes
a first tapered waveguide, and
a second tapered waveguide that is connected to the first tapered waveguide,
the second waveguide includes
a third tapered waveguide that is disposed side by side with the first waveguides, and
a third waveguide that is connected to the third tapered waveguide on a side opposite to a side on which the first tapered waveguides are provided,
each of the first tapered waveguides has a structure constituted such that a waveguide width is gradually wider as the first tapered waveguide is closer to the associated second tapered waveguide,
each of the second tapered waveguides has a structure constituted such that a waveguide width is gradually narrower as the second tapered waveguide is farther away from the associated first tapered waveguide,
the third tapered waveguide has a structure constituted such that a waveguide width is gradually wider as the third tapered waveguide is closer to the third waveguide, and
each of the first waveguides has a structure constituted such that a first gap between the two first waveguides at a start point of each of the first tapered waveguides is made wider than a second gap between the two first waveguides at a connection portion between each of the first tapered waveguides and the associated second tapered waveguides.

2. The optical device according to claim 1, wherein each of the first waveguides has a structure constituted such that a third gap between the two second tapered waveguides at an end point of each of the second tapered waveguides is made narrower than the second gap.

3. The optical device according to claim 1, wherein each of the first waveguides includes a bent waveguide that is optically coupled to an end point of each of the second tapered waveguides and that is gradually away from the third waveguide disposed in the second waveguide.

4. The optical device according to claim 1, wherein
each of the first waveguides covered by a clad on the substrate is made of a material including Silicon Nitride (SiN),
the second waveguide covered by a clad on the substrate is made of a material including Silicon (Si), and
the clad is made of a material including SiO₂.

5. The optical device according to claim 1, wherein, when the first waveguides and the second waveguide are covered by a clad on the substrate,
a refractive index of a material of the clad is made smaller than a refractive index of a material of each of the first waveguides, and
the refractive index of the material of each of the first waveguides is made smaller than a refractive index of a material of the second waveguide.

6. The optical device according to claim 1, wherein the first waveguides and the second waveguide are rib waveguides.

7. An optical communication apparatus comprising:
a light source;
an optical transmitter that performs optical modulation on light received from the light source by using a transmission signal and that transmits transmission light; and
an optical device that guides the light inside the optical transmitter, wherein
the optical device includes
two first waveguides that are arranged side by side on a substrate, and
a single second waveguide that is arranged, on the substrate, so as to be side by side with and away from the first waveguides,
each of the first waveguides includes
a first tapered waveguide, and
a second tapered waveguide that is connected to the first tapered waveguide,
the second waveguide includes
a third tapered waveguide that is disposed side by side with the first waveguides, and
a third waveguide that is connected to the third tapered waveguide on a side opposite to a side on which the first tapered waveguides are provided,
each of the first tapered waveguides has a structure constituted such that a waveguide width is gradually wider as the first tapered waveguide is closer to the associated second tapered waveguide,
each of the second tapered waveguides has a structure constituted such that a waveguide width is gradually narrower as the second tapered waveguide is farther away from the associated first tapered waveguide,
the third tapered waveguide has a structure constituted such that a waveguide width is gradually wider as the third tapered waveguide is closer to the third waveguide, and
each of the first waveguides has a structure constituted such that a first gap between the two first waveguides at a start point of each of the first tapered waveguides is made wider than a second gap between the two first waveguides at a connection portion between each of the first tapered waveguides and the associated second tapered waveguides.

8. An optical communication apparatus comprising:
a light source;
an optical receiver that receives a reception signal from reception light by using light received from the light source; and
an optical device that guides the light inside the optical receiver, wherein
the optical device includes
two first waveguides that are arranged side by side on a substrate, and
a single second waveguide that is arranged, on the substrate, so as to be side by side with and away from the first waveguides,
each of the first waveguides includes
a first tapered waveguide, and
a second tapered waveguide that is connected to the first tapered waveguide,
the second waveguide includes
a third tapered waveguide that is disposed side by side with the first waveguides, and
a third waveguide that is connected to the third tapered waveguide on a side opposite to a side on which the first tapered waveguides are provided,
each of the first tapered waveguides has a structure constituted such that a waveguide width is gradually wider as the first tapered waveguide is closer to the associated second tapered waveguide,
each of the second tapered waveguides has a structure constituted such that a waveguide width is gradually narrower as the second tapered waveguide is farther away from the associated first tapered waveguide,
the third tapered waveguide has a structure constituted such that a waveguide width is gradually wider as the third tapered waveguide is closer to the third waveguide, and
each of the first waveguides has a structure constituted such that a first gap between the two first waveguides at a start point of each of the first tapered waveguides is made wider than a second gap between the two first waveguides at a connection portion between each of the first tapered waveguides and the associated second tapered waveguides.
